(19) United States
(12) Patent Application Publication
(10) Pub. No.: US 2010/0259168 A1
(43) Pub. Date: Oct. 14, 2010

(54) Excimer discharge lamp

(75) Inventors: Kengo Moriyasu, Hyogo (JP); Yukihiro Morimoto, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/662,214

(22) Filed: Apr. 6, 2010

(30) Foreign Application Priority Data
Apr. 10, 2009 (JP) 2009-095894

(51) Int. Cl. H01J 65/04

(52) U.S. Cl. 313/607

(57) ABSTRACT

An excimer discharge lamp comprises an electric discharge container and a pair of electrodes provided in an outer face of the electric discharge container, wherein the electric discharge container is made up of a tubular side wall on which the pair of electrodes are provided, one end wall that seals one end of the tubular side wall, and another end wall that seals another end of the tubular side wall, wherein a chip pipe made of metal or an alloy is formed on the another end wall, and wherein a dividing wall made of sapphire, YAG, or single crystal yttria is provided at a portion of the another end wall that is located in a shortest distance portion between the chip pipe and an inner face of the side wall on which the pair of electrodes is provided.

### CROSS-REFERENCES TO RELATED APPLICATION

This application claims priority from Japanese Patent Application Serial No. 2009-095894 filed Apr. 10, 2009, the contents of which are incorporated herein by reference in their entirety.

### TECHNICAL FIELD

The present invention relates to an excimer discharge lamp which emits ultraviolet rays by excimer electric discharge. Especially, the present invention relates to an excimer discharge lamp whose electric discharge container is made of sapphire, YAG, or single crystal yttria.

### BACKGROUND

Conventionally, an excimer discharge lamp has been used, as an ultraviolet ray light source, for a photochemical reaction, such as photo-cleaning, surface alteration and sensitization of a chemical substance. For example, rare gas such as xenon and halide such as fluoride, which are enclosed in this excimer discharge lamp, are known as light emission gas. The halogen or halide is ionized at time of lamp lighting, so as to serve as halogen ions, and the reactivity thereof to other substances becomes very high. For this reason, measures against it are required for an electric discharge container of such an excimer discharge lamp, which encloses such halogen or halide. Japanese Patent Application Publication No. H06-310106 teaches such an excimer discharge lamp in which the measures therefor are taken.

FIG. 5 is an explanatory cross sectional view of an end portion of an excimer discharge lamp 9 disclosed in the-Japanese Patent Application Publication No. H06-310106. The excimer discharge lamp 9 is made up of an electric discharge container 91 made from a sapphire pipe, a titanium cap 911 that is provided at both ends of the electric discharge container 91, and metal nets 93 that are provided on an outer face of the electric discharge container 91, so as to be apart from each other.

The electric discharge container 91 is sealed by the titanium caps using O rings 921 made of fluorine contained resin system, so that an airtight electrical discharge space is formed inside the electric discharge container 91. This electrical discharge space is filled up with xenon gas and chlorine as the electric discharge gas.

A power supply, which is not illustrated in the figure, is connected to the metal nets 93, and high voltage of high frequency is impressed thereto, to start the electric discharge. In the electrical discharge space, excimer electric discharge arises, so that ultraviolet rays with a wavelength band of 300 to 320 nm resulting from the xenon and chlorine, are acquired. Since the sapphire pipe 91 has ultraviolet-ray permeability, the lamp emits the ultraviolet rays produced by the excimer electric discharge to the outside of the lamp 9.

In the above-mentioned excimer discharge lamp 9, in order to enclose the electric discharge gas in the electrical discharge space, it is necessary to form a chip pipe in the titanium cap 911. For this reason, an excimer discharge lamp shown in FIG. 6, which is an overall view thereof, can be considered.

Portions of FIG. 6, which are different from those shown in FIG. 5, will be described below, while descriptions of portions in common with each other are omitted. The chip pipe 94, which leads to the electrical discharge space, is connected to the titanium cap 911 provided at one end of the electric discharge container 91 by brazing or other method. Electric discharge gas is enclosed in the electrical discharge space through the chip pipe 94. After enclosing it, the chip pipe 94 is sealed and cut off in order to seal up the electrical discharge space, thereby forming the sealing portion 941 shown in FIG. 6. Material that can be sealed and cut off is used for the chip pipe 94, such as a metal.

### SUMMARY

When the excimer discharge lamp 9 as shown in FIG. 6 is turned on, electric discharge sometimes does not occur between the pair of metal nets 93.

Although high voltage is impressed to one of the metal nets 93 at time of lamp lighting, since the chip pipe 94 is at low voltage with respect to this high voltage, electric discharge has arisen between the one of the metal nets 93 and the chip pipe 94.

If electric discharge arises between the one of the metal nets 93 and the chip pipe 94, the chip pipe 94 is heated, so that the thermal expansion difference between the cap 911 and the chip pipe 94 occurs at the brazed portion whereby it may be damaged.

Moreover, even though the portion between the cap 911 and the chip pipe 94 is not damaged, when the chip pipe 94 is heated, the O ring 922 is heated through the cap 911, so that the O ring 922 deteriorates, and the airtightness of the electric discharge container 91 may not be maintained.

It is an object of the present invention to offer an excimer discharge lamp in which electric discharge to a chip pipe is suppressed.

An excimer discharge lamp comprises an electric discharge container that has an electrical discharge space, a pair of electrodes provided in an outer face of the electric discharge container. The electrical discharge space encloses at least a rare gas and halogen or halide as electric discharge gas. The electric discharge container is made up of a tubular side wall on which the pair of electrodes are provided. One end wall seals one end of the tubular side wall, and another end wall seals another end of the tubular side wall. The one end wall and the another end wall are made of sapphire, YAG, or single crystal yttrias. A chip pipe made of metal or an alloy is formed on the another end wall, and wherein a dividing wall made of sapphire, YAG, or single crystal yttria is provided at a portion of the another end wall that is located in a shortest distance between the chip pipe and an inner face of the side wall on which the pair of electrodes is provided.

In the excimer discharge lamp according to the present invention, it is possible to make resistance high between the chip pipe and the inner face where the pair of electrodes is provided, thereby suppressing the electric discharge to the chip pipe.

### BRIEF DESCRIPTION OF DRAWINGS

Other features and advantages of the present excimer discharge lamp will be apparent from the ensuing description, taken in conjunction with the accompanying drawings, in which:

FIG. 1 is an explanatory diagram of an excimer discharge lamp according to the present invention;

FIGS. 2A-2D are explanatory diagrams of an excimer discharge lamp according to the present invention;

FIGS. 3A-3C is an explanatory diagram of an excimer discharge lamp according to the present invention;

FIG. 4 is an explanatory diagram showing an experimental result;

FIG. 5 is an explanatory diagram of a conventional excimer discharge lamp; and

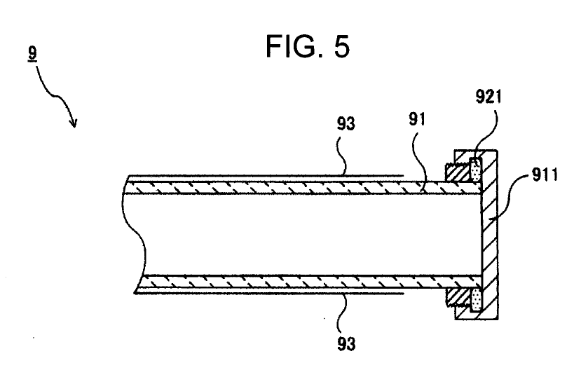

FIG. 6 is an explanatory diagram of an excimer discharge lamp for explaining a subject matter.

### DESCRIPTION

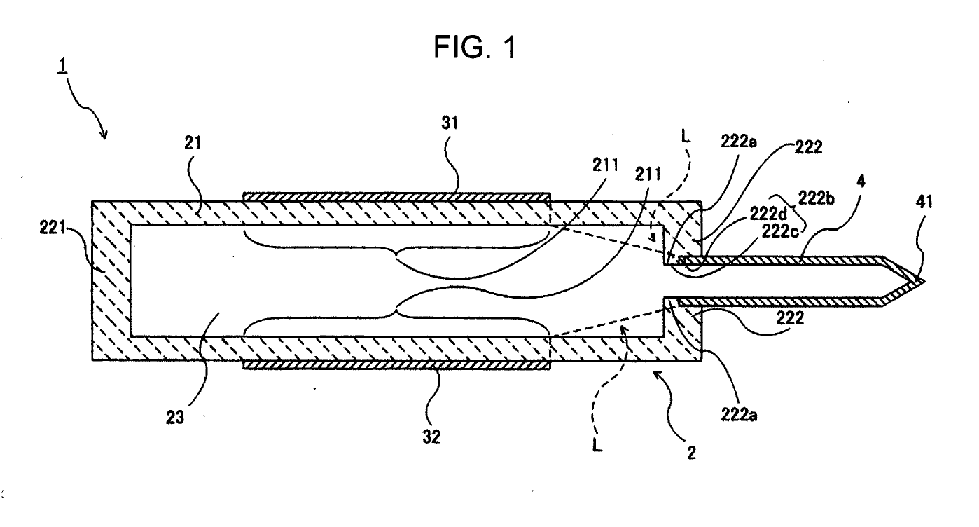

FIG. 1 is an explanatory cross sectional view of an excimer discharge lamp 1 according to a first embodiment, taken in a longitudinal direction of an electric discharge container 2.

The excimer discharge lamp 1 according to the first embodiment is made up of the straight tube shaped electric discharge container 2, a chip pipe 4 formed in an end of the electric discharge container 2, and a pair of electrodes 31 and 32 provided apart from each other on an outer surface of the electric discharge container 2.

This electric discharge container 2 is made up of the straight tube shaped side wall 21, one end wall 221 in shape of a plate, which is provided at an end of the side wall 21, and another annular end wall 222 provided at the other end of the side wall 21, and is made of sapphire (single crystal alumina Al₂O₃), YAG (yttrium aluminum Garnett), or single crystal yttria (Y₂O₃). A hole 222b which penetrates the other end wall 222 at the center thereof is formed. This hole 222b is made up of a small diameter hole 222c located in a left side of the hole 222b in the figure, and a large diameter hole 222d, which is continuous from the small diameter hole 222c, and has a larger diameter than that of the small diameter hole 222c. A level difference is formed by the small diameter hole 222c and the large diameter hole 222d therebetween, that is, the level difference serves as a dividing wall 222a.

Part of the outer circumference of the chip pipe 4 is inserted in the large diameter hole 222d of the end wall 222, and one end portion of the chip pipe 4 (end portion in the left hand side of the chip pipe 4 in the figure) is brought into contact with the dividing wall 222a. Metallization is performed on a face that forms the large diameter hole 222d, and brazing metal, such as silver solder, is filled up between the chip pipe 4 and the face. Since the chip pipe 4 is made of metal material, such as nickel or an alloy material (such as a nickel-chromium (Ni—Cr) system alloy, a nickel-copper (Ni—Cu) system alloy or a nickel-iron (Ni—Fe) system alloy), the chip pipe 4 is joined through brazing metal on the face where the metallization is performed. In addition, there is an active metal brazing method as a method for joining metal and ceramics. Therefore, the chip pipe 4 may be joined with the other end wall 222 by using this active metal brazing method. Specifically, active metal brazing, which contains active metal such as titanium, is used as brazing metal, and the chip pipe 4 and the face that forms the large diameter hole 222d are joined by the active metal brazing. In the case of the active metal brazing method, the metallization may not be necessarily performed on the face, which forms the large diameter hole 222d.

A sealing portion 41 is formed by performing pressure welding on the other end portion of the chip pipe 4 (end portion of the right hand side of the chip pipe 4 in the figure). In this way, the airtight electrical discharge space 23 is formed inside the electric discharge container 2. The electrical discharge space 23 encloses a rare gas, such as argon (Ar), krypton (Kr) and xenon (Xe), and halogen, such as fluoride (F₂), chlorine (Cl₂), bromine (Br₂) and iodine (I₂), or halide such as sulfur hexafluoride (SF6) as an electric discharge gas.

A pair of electrodes 31 and 32 are arranged apart from each other on an outer surface of the electric discharge container 2. Thus, the pair of electrodes 31 and 32 face each other through the side wall 21 and the electrical discharge space 23 of the electric discharge container 2.

In the excimer discharge lamp 1 according to the first embodiment, the dividing wall 222a is provided on the shortest distance (portion) L between the chip pipe 4 and the inner face 211 of the side wall 21 on which the one electrode 31 is provided. The dividing wall 222a is also provided on the shortest distance (portion) L between the chip pipe 4 and the inner face 211 of the side wall 21 on which the electrode 32 is provided. In addition, the “shortest distance (part) L” according to the first embodiment means, as shown in FIG. 1, part between a portion of the inner face 211 corresponding to a portion of the side wall 21 on which the pair of electrodes 31 and 32 ire formed, and which is closest to the chip pipe 4, and a portion of the chip pipe 4 which is closest to the above mentioned portion (in FIG. 1, one end portion in the left hand side of the figure). In the first embodiment, since the shortest distance L between the chip pipe 4 and the inner face 211 of the side wall 21 on which the one electrode 31 is provided, is approximately the same as the shortest distance L between the chip pipe 4 and the inner face 211 of the side wall 21 on which the electrode 32 is provided, the dividing walls 222a are provided on both of the shortest distance parts L. Thus, the dividing walls 222a provided on the respective shortest distance L are provided at the respective portions of the end wall 222, which are located on straight lines representing the shortest distance L (in FIG. 1, dotted lines show the shortest distance portions L).

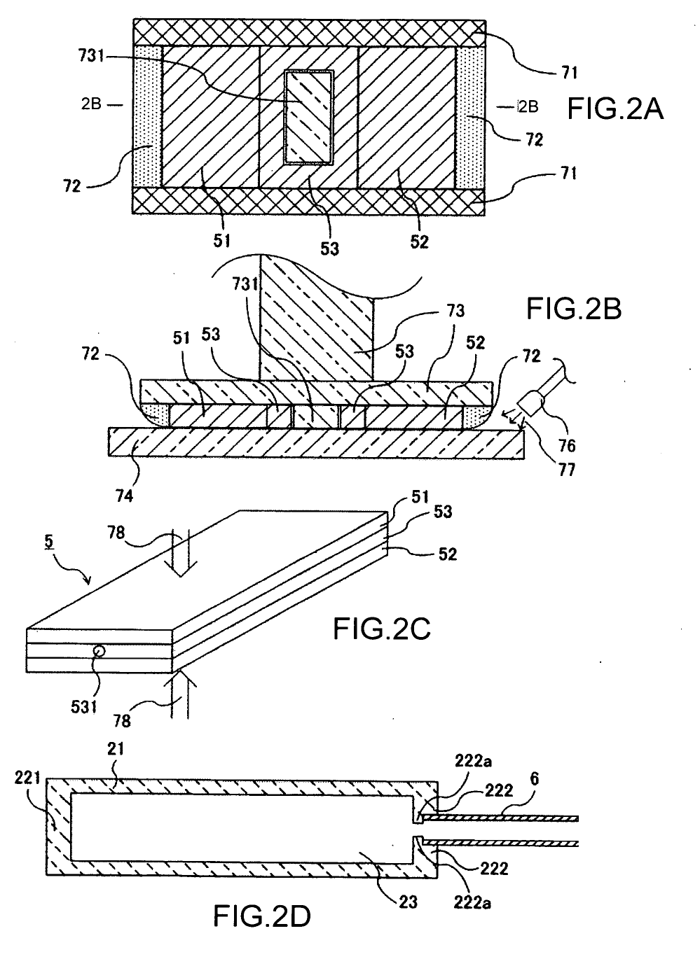

Next, examples of a manufacture method of the excimer discharge lamp 1 are explained, referring to FIGS. 2A, 2B, 2C and 2D. FIG. 2A is a top plan view of a pair of plate members 51 and 52 and a rectangular member 53, which are fixed in a jig 71. FIG. 2B is a cross sectional view of the pair of plate members 51 and 52 and the rectangular member 53, which are shown in FIG. 2A, showing a grinding step thereof (which is taken along the line 2B-2B of FIG. 2A). FIG. 2C is a perspective view thereof, showing a step of heating the pair of plate members 51 and 52 and the rectangular member 53 while pressing them after the grinding step of FIG. 2B. FIG. 2D is a cross sectional view thereof, showing a joining step in which a chip pipe forming material 6 is joined to a discharge container forming material 5 that has been joined in the step shown in FIG. 2C. In addition, in FIGS. 2A-2D, the same numerals as those in FIG. 1 are assigned to the same structures as those shown in FIG. 1.

For example, three plate members made of sapphire are prepared, and a rectangular hole is formed in one of the plate members so as to penetrate a central part thereof, thereby forming the rectangular member 53. As shown in FIG. 2A, for example, when grinding a face of one rectangular member 53 in the front side of FIG. 2A, the rectangular member 53 is arranged on a support stand (which is indicated as “73” in FIG. 2B, although not shown in FIG. 2A), so as to locate that face in the front side of FIG. 2A. Since a jig 731 for a hole is provided on the support stand 73, the rectangular member 53 is arranged on the support stand 73 so that the jig 731 for a hole may be located at the center hole. Then, two plate members 51 and 52 are arranged on the right and left of the rectangular member 53 in a state where the faces to be ground face toward the front side of FIG. 2A. The two plate members 51 and 52 and the one rectangular member 53 are surrounded by the jig 71 and an adhesive agent 72 in the outer circumference thereof, so that they are fixed to the support stand (In FIG. 2B, the support stand is indicated as 73 although not shown in FIG. 2A).

As shown in FIG. 2B, the two plate members 51 and 52 and the one rectangular member 53, which have been fixed as shown in FIG. 2A, are placed so that the faces to be ground (faces thereof in a lower side of FIG. 2B) face a grinding stand 74. In the grinding process, in order to perform three grinding steps, the so-called “grinding” step, “lapping” step, and “polishing” step, the grinding stand 74 and the particle size of the abrading agent 77 are changed in each step of the grinding. First, in the so called “grinding” step in the grinding process, steel is used as the grinding stand 74. The faces of the two plate members 51 and 52 and the one rectangular member 53, which face the grinding stand 74, are ground by the unevenness of the grinding stand 74 and the abrading agent 77, which is, for example, silicon dioxide (SiO₂), silicon carbide (SiC), diamond (C), or cerium dioxide (CeO₂) supplied by an abrading agent supply unit 76 between the grinding stand 74 and the faces to be ground. Next, at least a face in an opposite side to the ground face of the one rectangular member 53 (a face in an upper side of FIG. 2B) is ground. Then in the so called “wlapping” step of the grinding process, tin is used as the grinding stand 74. The faces of the two plate members 51 and 52 and the one rectangular member 53, which face the grinding stand 74, are again ground by the unevenness of the grinding stand 74 and the abrading agent 77, which is, for example, silicon dioxide (SiO₂), silicon carbide (SiC), diamond (C), or cerium dioxide (CeO₂) supplied by the abrading agent supply unit 76, between the grinding stand 74 and the faces to be ground. The particle size of the abrading agent which is used at this time, is smaller than that of the abrading agent that was used at the time of the “grinding” step. Next, at least a face of the one rectangular member 53, which is in an opposite side of the ground face (a face in a lower side of FIG. 2B), is again ground. Finally, in the “polishing” step of the grinding process, aluminum, to which resin is applied, is used as the grinding stand 74. The faces of the two plate members 51 and 52 and the one annular member 5,3 which face the grinding stand 74, are ground again by the abrading agent 77, which is, for example, silicon dioxide (SiO₂), silicon carbide (SiC), diamond (C), and cerium dioxide (CeO₂) supplied by the abrading agent supply unit 76, between the faces to be ground and the resin of the grinding stand 74. The particle size of the abrading agent 77 used at this time is smaller than that of the abrading agent 77 used at the time of the “wlapping” step. Next, at least a face of the one rectangular member 53, which is in an opposite side of the ground face (a face in an upper side of FIG. 2B), is again ground. Thus, the two plate members 51 and 52 and the one side wall member 53 pass through the three grinding steps of the “grinding” process, the “wlapping” step, and the “polishing” step, and the particle size of the abrading agent 77 becomes gradually smaller, so that the smoothness of the ground surface can be improved.

After grinding the two plate members 51 and 52 and the one rectangular member 53 in FIG. 2B, the ground faces thereof are brought into contact with each other so that the two plate members 51 and 52 may be arranged so as to face each other through the one rectangular member 53, and so that the laminated members are formed. Description thereof will be given below referring to FIG. 2C. One of the ground faces of the rectangular member 53 is brought into contact with one of the ground faces of the plate member 51 (a face in an upper side of FIG. 2C). Moreover, the other ground face of the plate member 52 is brought into contact with the other ground face (a face in a lower side of FIG. 2C) of the rectangular member 53, so that the hole of the rectangular member 53 may be surrounded by the pair of plate members 51 and 52. The outer faces of the pair of plates 51 and 52 (the face in an upper side of one of the plate members 51 of FIG. 2C and the face in a lower side of the other plate member 52 of FIG. 2C) are pressed by a pressing unit 78 (not shown), so that the ground faces of the two plate members 51 and 52 and the one rectangular member 53 are brought into close contact with each other in a state where they are laminated. While the two plate members 51 and 52 and the one rectangular member 53 are laminated and pressed, they are heated at, for example, 1300-1400 degrees Celsius for 8 to 15 hours under reduced pressure.

After heating in FIG. 2C, the faces of the two plate members 51 and 52 and the one rectangular member 53, which have been cooled down to room temperature, are joined to each other on the faces that were respectively brought into contact with each other, thereby forming an integrated member so as to serve as an electric discharge container forming member 5. In the electric discharge container forming member 5, as shown in FIG. 2D, the electric discharge space 23 resulting from the rectangular member 53 is formed in the inside thereof, and a through hole 531 that leads to the electric discharge space 23 is formed in the other end wall 222 in the longitudinal direction. In the through hole 531, the level difference is formed between the small diameter hole 222c and the large diameter hole 222d, and this level difference serves as the dividing wall 222a. After the metallization is performed with copper on the large diameter hole 222d, an end of the chip pipe forming member 6, which is made of nickel, is inserted therein. Brazing metal is filled in by silver soldering between the large diameter hole 222d and the outer circumferential face of the chip pipe forming member 6, so that both are joined to each other. After air in the hollow part thereof is discharged from the other end of the chip pipe forming member 6, argon and sulfur hexafluoride (SF6) are enclosed as electric discharge gas in this hollow part of the electric discharge container forming member 5. Since the chip pipe forming member 6 is made of metal, the sealing portion 41 can be formed by performing pressure welding on the other end portion of the chip pipe forming member 6. As a result, the hollow part of the electric discharge forming member 5 becomes the airtight electric discharge space 23 thereby serving as the electric discharge container 2.

Although not shown in the figure, the net electrodes 31 and 32 are formed on the pair of the outer faces of the electric discharge container 2. The net electrodes are formed by applying, for example, copper paste in a shape of the net on the outer faces of the electric discharge container 2 by printing, and then heating the applied paste copper together with the electric discharge container 2 at high temperature, so as to perform calcination on the paste copper. Thereby, the excimer discharge lamp 1 is completed. When the excimer discharge lamp 1 according to the present invention is formed in such a manner, it is possible to form the sealed electric discharge space 23 without using a resin component.

In addition, the electric discharge container 2 may be a rectangular parallelepiped, which is a rectangle in a cross sectional view thereof taken in a direction perpendicular to a longitudinal direction, or may be a cylindrical shape, which is a circle in a cross sectional view thereof taken therein.

A power supply, which is not illustrated, is connected to the pair of electrodes 31 and 32 of the excimer discharge lamp 1 according to the first embodiment. Next, description of a lighting operation of the excimer discharge lamp 1 will be given below.

When a high voltage of a high frequency is supplied to the excimer discharge lamp 1, electric charges are accumulated on an inner face of the electric discharge container 2 on which the high voltage side electrode (for example, one electrode 31) is formed, and the electric charges move toward the low voltage side electrode (for example, the other electrode 32). When the electric discharge gas is argon and sulfur hexafluoride (SF6), the electric discharge gas is ionized in response to the electric charges, so that argon ions and fluoride ions are formed. The excimer molecules, which consist of argon and fluoride, are formed from these ions, so that ultraviolet rays with a wavelength of 193 nm are generated. The electric discharge container 2 is exposed to the fluoride ions at this time, and since the electric discharge container 2 is made of sapphire, YAG or single crystal yttria, and its reactivity with halogen ions is low, the discharge container 2 can be used for a long time. Furthermore, since, unlike the prior art, the airtight electrical discharge space 23 is formed without using a resin component for the present electric discharge container 2, there is no problem of degradation of such a resin component. Therefore, it is possible to maintain the airtightness of the electric discharge space 23 for a long time.

Since the electric discharge container 2 has ultraviolet-rays permeability, it is possible to emit the 193 nm ultraviolet rays produced in the electrical discharge space 23 to the outside thereof.

The chip pipe 4 is made from a metal member or an alloy member in order to form the sealing portion 41 of the excimer discharge lamp 1 according to the first embodiment. For this reason, at time of lamp lighting, both the low voltage side electrode (hereinafter, for example, the other electrode 32) and the chip pipe 4, are also in a low-voltage state with respect to the high voltage side electrode (hereinafter, for example, one electrode 31), so that an electric field may be generated between the high voltage side electrode 31 and the chip pipe 4. At this time, electric charges are accumulated in the inner face 211 of the side wall 21 on which the high voltage side electrode 31 is provided, so that the electric charges may cause electric discharge toward the chip pipe 4. Therefore, in the excimer discharge lamp 1 according to the first embodiment, at the end wall 222 located on the shortest distance L between the chip pipe 4 and the inner face of the side wall on which the pair of electrodes 31 and 32 is provided, the dividing wall 222a made of sapphire, YAG, or single crystal yttria is formed. The electric resistance nature of the dividing wall 222a is higher than that of the chip pipe 4, and is also higher than the electrodes 31 and 32. For this reason, in the first embodiment, it is possible to make the resistance high, by providing the dividing wall 222a between the chip pipes 4 and the inner face on which the pair of electrodes 31 and 32 is provided, thereby suppressing generation of such electric discharge.

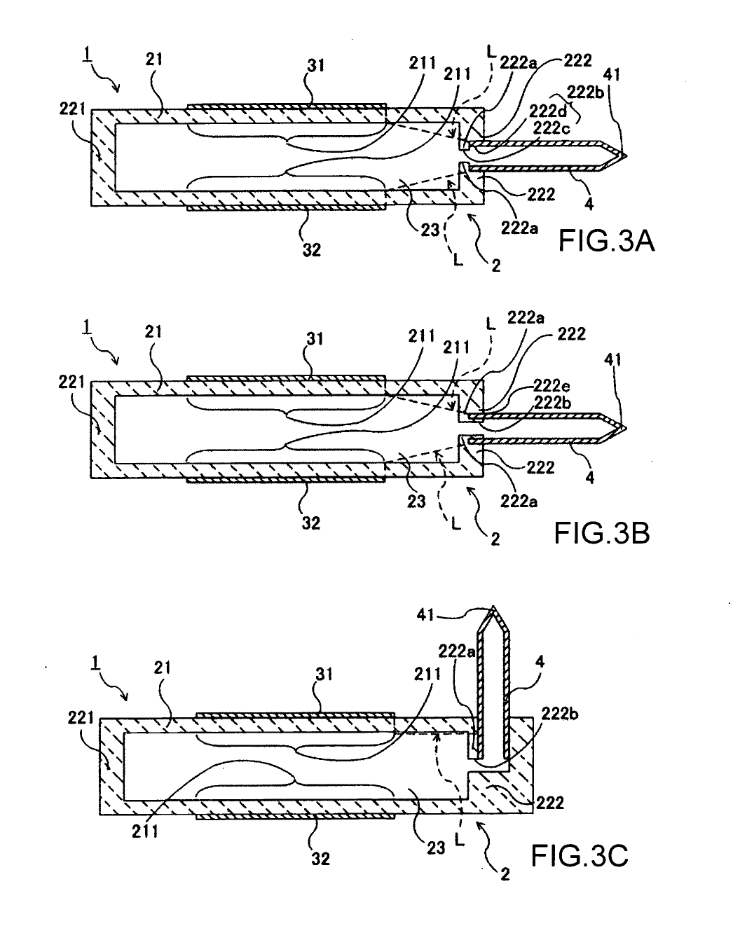

In addition to the first embodiment, FIGS. 3A-3C show another embodiment according to the present invention.

FIG. 3A is an explanatory cross sectional view of an excimer discharge lamp 1 according to a second embodiment, taken in a longitudinal direction of an electric discharge container 2. In addition, in FIG. 3A, the same numerals as those of FIG. 1 are assigned to the same structural elements as those of FIG. 1.

FIG. 3A is different from FIG. 1, in that a level difference (a dividing wall 222a) formed by a small diameter hole 222c and a large diameter hole 222d is larger than the level difference of FIG. 1. In the description of the structure according to the second embodiment, which is shown in FIG. 3A, portions that are in common with those of FIG. 1 will not be described, while portions that are different from will be described below.

The small diameter hole 222c provided in an end wall 222 is much smaller than the small diameter hole 222c shown in FIG. 1. For this reason, the height of the dividing wall 222a, which extends toward the central axis of the electric discharge container 2, is greater than the dividing wall 222a of FIG. 1.

In the second embodiment, the dividing wall 222a made of sapphire, YAG, or single crystal yttria is formed at the end wall 222 located on the shortest distance L between the chip pipe 4 and the inner face 211 of the side wall 21 on which a pair of electrodes 31 and 32 is provided. Therefore, similar effects to those of the first embodiment can be obtained.

FIG. 3B is an explanatory cross sectional view of an excimer discharge lamp 1 according to a third embodiment, taken in a longitudinal direction of an electric discharge container 2. In addition, in FIG. 3B, the same numerals as those in FIG. 1 are assigned to the same structures as those shown in FIG. 1.

FIG. 3B is different from FIG. 1, in that a through hole is made up of only a small diameter hole, and the small diameter hole is not connected to a large diameter hole. In the description of the structure according to the third embodiment, which is shown in FIG. 3B, portions different from those of FIG. 1 will be described below, while the description of portions in common with those of FIG. 1 is omitted.

An hole 222c that penetrates the center of the other end wall 222 is formed therein. An annular concave portion 222e, which is not connected to the through hole 222b, is formed in an outside of the other end wall 222, (an outer face in the right hand side of FIG. 3B), and in the position of the circumferential direction of the through hole 222b. Metallization is performed on this concave portion 222e, and a chip pipe 4 is connected thereto through brazing metal, such as silver solder.

In the third embodiment, a dividing wall 222a made of sapphire, YAG, or single crystal yttria is formed at the end wall 222 located on the shortest distance L between the chip pipe 4 and the inner face 211 of the side wall 21 on which the pair of electrodes 31 and 32 is provided. Therefore, similar effects to those of the first embodiment can be obtained.

FIG. 3C is an explanatory cross sectional view of an excimer discharge lamp 1 according to a fourth embodiment, taken in a longitudinal direction of an electric discharge container 2. In addition, in FIG. 3C, the same numerals as those in FIG. 1 are assigned to the same structures as those shown in FIG. 1.

FIG. 3C is different from FIG. 1, in that a through hole 222b has an L-shaped cross sectional view thereof. In the description of the structure according to the fourth embodiment, which is shown in FIG. 3C, portions that are different from those of FIG. 1 will be described below, while portions that are in common with those of FIG. 1 will not be described.

A hole 222b, which extends along the central axis of an electric discharge container 2, is formed in the other side of the end wall 222, and in the middle of the other side end wall 222, this hole 222b extends perpendicular to the central axis of the electric discharge container 2 therefrom, so that an electrical discharge space 23 and the inner side of a chip pipe 4 are connected to each other. The chip pipe is inserted in a hole provided in the end wall 222 and joined thereto by a brazing metal. In the fourth embodiment, a power supply, which is not illustrated, is connected to the pair of electrodes 31 and 32, one of which serves as a high voltage side electrode, and the other one of which serves as a low voltage side electrode. However, a dividing wall 222a made of sapphire, YAG, or single crystal yttria is formed at the end wall 222 located on the shortest distance L between the chip pipe 4 and the inner face 211 of the side wall 21 on which the pair of electrodes 31 and 32 are provided. That is, since in the fourth embodiment, at the end wall 222 located on the shortest distance L between the chip pipe 4 and the inner face 211 of the side wall 21 on which the pair of electrodes 31 and 32 is provided, the dividing wall 222a made of sapphire, YAG, or single crystal yttria is formed, it is possible to obtain similar effects to those of the first embodiment. In addition, the “shortest distance L” according to the fourth embodiment, means, as shown in FIG. 3C, part between a portion which is on the inner face 211 corresponding to a portion of the side wall 21 on which the pair of electrodes 31 and 32 is formed, and which is closest to the chip pipe 4, and a portion of the chip pipe 4 which is closest to the portion. The length of the shortest distance portion L between the chip pipe 4 and the inner face 211 of the side wall 21 on which the one electrode 31 is provided, is, shorter than that of the shortest distance portion L between the chip pipe 4 and the inner face 211 of the side wall 21 on which the other electrode 32 is formed. Therefore, in the fourth embodiment, the dividing wall 222a is provided in the end wall 222 located on the shortest distance L between the chip pipe 4 and the inner face 211 of the side wall 21 on which the one electrode 32 is provided.

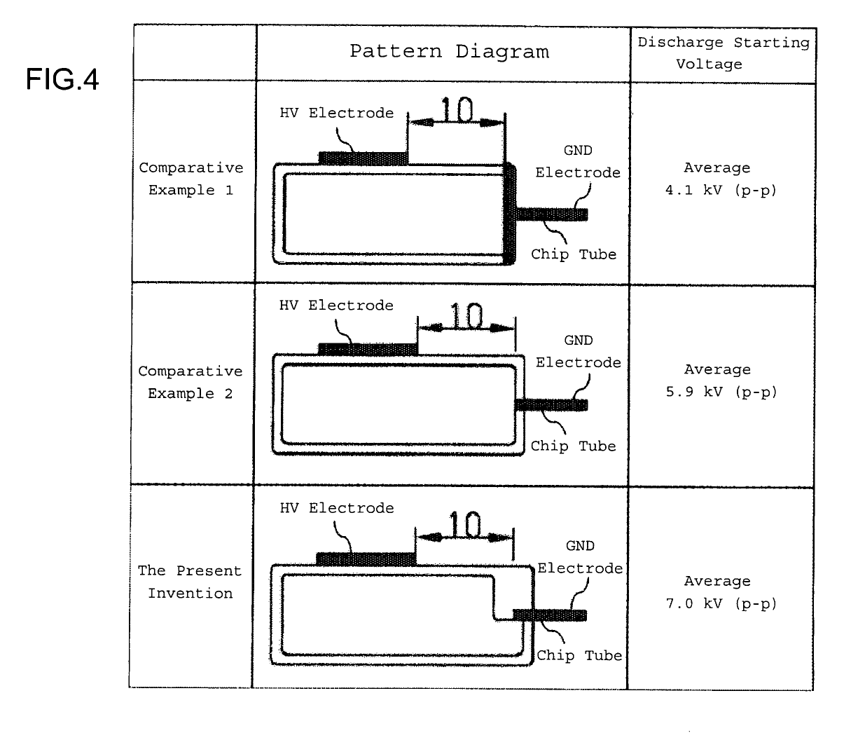

Next, an experiment showing effects of the excimer discharge lamp according to the present invention is explained below. In the experiment, three kinds of excimer discharge lamps were prepared. Two of these three kinds of lamps were prepared as comparative examples, and the remaining one was prepared according to the present invention. FIG. 4 shows a pattern diagram of these excimer discharge lamps.

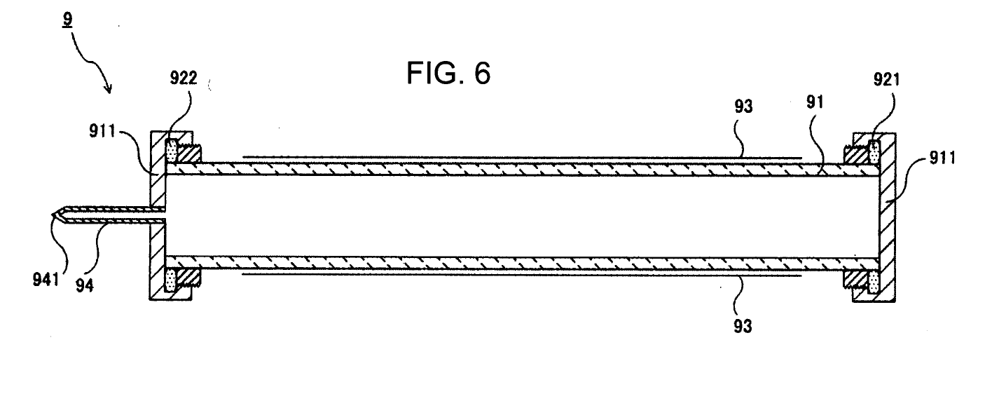

The comparative example 1 of FIG. 4 was prepared in imitation of the structure of the excimer discharge lamp shown in FIG. 6. The comparative example 1 of FIG. 4 differs from that shown in FIG. 6, in that, in the comparative example, a low voltage side electrode was removed, and an electric discharge container and a cap were joined and sealed by active metal soldering, but not by an O ring sealing. The comparative example 2 was different from the comparative example 1, in that the electric discharge container was made by directly joining sapphire members, without using any resin component. At this time, no dividing wall was provided between a chip pipe and an inner face of a side wall on which an electrode was provided. The excimer discharge lamp according to the present invention was prepared in imitation of the structure shown in FIG. 1, and a low voltage side electrode (for example, the other electrode 32) was removed, and a dividing wall provided between the low voltage side electrode and a chip pipe was removed.

As common portions among these excimer discharge lamps, sapphire was used for the electric discharge container, nickel was used for the chip pipe, copper in form of paste, which was calcinated, was used for the electrode, and argon gas was used for electric discharge gas. As a peculiar structure of the comparative example 1, nickel was used for a cap.

The specification (dimension etc.) common to these excimer discharge lamps will be described below. The width (the length in up-and-down directions in FIGS. 3A-3C) of the electric discharge container 2 was 10 mm. The length (the length of a horizontal direction in FIGS. 3A-3C) of the electric discharge container was 100 mm. The height (the length of a front-back direction in FIGS. 3A-3C) of the electric discharge container 2 was 10 mm. Sealing pressure of the electric discharge gas was 13.3 kPa and the distance from an electrode to an end wall was 10 mm.

In the experiment, the electrode was used as the high voltage side electrode, and the chip pipe was connected to a power supply as a ground side electrode, in which voltage (electric discharge starting voltage) was measured until electric discharge started between the electrode and the chip pipe. The electric discharge starting voltage of the respective excimer discharge lamps 1 was measured five times, and the average value thereof was calculated, respectively. Since in the comparative example 1, nickel was used for the cap, the electrical connection was established between the chip pipe and the cap, so that electric discharge begun between the cap and the electrode. On the other hand, since, in the comparative example 2, a sealed electric discharge container 2 was configured so as not to use metal cap, the electric shortest distance L between the electrode and the chip pipe became longer than that of the comparative example 1, so that the insulated space (electrical discharge space) thereof was extended, whereby the electric discharge starting voltage became larger than that of the comparative example 1 by 1.8 kV (p-p). Furthermore, in the present invention, since the dividing wall was provided between the chip pipe and the inner face of the side wall on which the electrode was provided, this dividing wall functions as an insulator, so that electric discharge starting voltage became larger than that of the comparative example 2 by 1.1 kV (p-p).

Thus, according to the present invention, it turned out that the electric discharge starting voltage could be made 70% higher than that in the case of the excimer discharge lamp of the prior art (comparative example 1). That is, since the electric discharge container of the excimer discharge lamp 1 according to the present invention was sealed airtightly without using any metal cap, and since the dividing wall was provided between the chip pipe and the inner face of the side wall on which the electrode was provided, the electric resistance thereof between the electrode and the chip pipe could be made high, and the electric discharge starting voltage could be increased.

The preceding description has been presented only to illustrate and describe exemplary embodiments of the present excimer discharge lamp. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. An excimer discharge lamp comprising:
an electric discharge container that has an electrical discharge space; and
a pair of electrodes provided in an outer face of the electric discharge container,
wherein the electrical discharge space encloses at least rare gas and halogen or halide as an electric discharge gas,
wherein the electric discharge container is made up of a tubular side wall, one end wall seals one end of the tubular side wall, and another end wall seals another end of the tubular side wall,
wherein the tubular side wall, the one end wall, and the another end wall are made of sapphire, YAG, or single crystal yttrias,
wherein a chip pipe made of a metal or an alloy is formed on the another end wall, and
wherein a dividing wall made of sapphire, YAG, or single crystal yttria is provided at a portion of the another end wall that is located in a shortest distance between the chip pipe and an inner face of the tubular side wall at which the one pair of the electrodes is provided.
